(19) United States
(12) Patent Application Publication
(10) Pub. No.: US 2002/0046076 A1
(43) Pub. Date: Apr. 18, 2002

(54) Multi-nodal meeting planning system and method

(76) Inventors: Daniel G. Baillargeon, Kihei, HI (US); John R. Hendrickson, Haiku, HI (US); Roxann M. Hendrickson, Haiku, HI (US)

Correspondence Address: GEORGE E. DARBY, P.O. BOX 893010, MILILANI, HI, 96789-3010, US

(21) Appl. No.: 09/954,089

(22) Filed: Sep. 14, 2001

Related U.S. Application Data
(60) Provisional application No. 60/232,663, filed on Sep. 14, 2000.
(60) Provisional application No. 60/238,196, filed on Oct. 4, 2000.
(60) Provisional application No. 60/294,535, filed on May 29, 2001.

(51) Int. Cl. G06F 17/60

(52) U.S. Cl. 705/8; 705/5

(57) ABSTRACT

The multi-nodal meeting planning system and method provides tools and capabilities that allow persons involved in planning, supporting, or participating in a meeting to design, prepare, operate, and assess the results of, a group meeting. The system uses at least one local node (110), at least one Remote Node (150), a distributed architecture, security, and data validation procedures tailored to the meeting planning industry.

### RELATED APPLICATIONS

This application claims the benefit of three provisional patent applications filed in the U.S. Patent and Trademark Office: (i) Ser. No. 60/232,663, filed on Sep. 14, 2000, for an invention entitled “Meeting Planning System with Exportable Database for Remote Node”; (ii) Ser. No. 60/238,196, filed on Oct. 4, 2000, for an invention entitled “Full-Circle Meeting Planning, Destination & Activity/Event Reservation Management System”; and (iii) Ser. No. 60/294,535, filed on May 29, 2001, for an invention entitled “Data Objects in Meeting Planning System”.

BACKGROUND OF THE INVENTION

1. Field of the Invention

This invention generally relates to a multi-node system for group meeting planning and onsite implementation of a planned group meeting, currently designated by the applicant as the PLANITDIRECT™ system. In particular, the system provides a comprehensive array of tools and capabilities that allow each person involved in planning, supporting, or participating in a meeting, be it a meeting planner, meeting facilitator, vendor providing products or services, or meeting participant, to efficiently and cohesively conceptualize, design, prepare, operate and assess the results of a group meeting, whether they be an individual or organization involved in any aspect of the meeting planning or implementation process. The system defined herein addresses the needs of all parties involved before, during, and after a group meeting, as well as maintaining one or more primary repositories and distributing data in use in a variety of locations to one or more remote nodes through a single system using electronic media, typically local area networks, wide area networks, the Internet and other data communications methods as they become available.

2. Description of Related Art

Currently in the group travel industry, there is no cohesive and secure system in place for handling all the aspects of planning and implementing a group program. From activities and events for group program participants that are booked via telephone call or fax to the research required for a meeting planner to assemble a group program, existing methods in use typically are fragmented and involve a lot of time and paperwork. Most operations are accomplished through telephone calls, e-mails, faxed documents and other time consuming methods, none of which specifically address all aspects of the meeting planning process in a way that allows an individual or organization to maintain adequate management control and have a system which allows a complete view of the group program before, during, and after the group program dates. For instance, even in the best of the systems currently available, planners must search through a variety of disconnected sources to plan their programs, participants purchase their activities on their own or through a third party reseller, and planner invoices after the program are generated with the assistance of an accounting department, paper vendor invoices and paper or electronic logs. Generally, this information comes from a variety of sources and formats, which must then be checked and manually integrated before a group program cost/price analysis or invoices can be generated.

Meeting planners have to handle a multitude of details to successfully coordinate a group program. Typically these include participant flight arrival and departure information, participant transportation services, participant activity booking, event creation and implementation, as well as costs and prices for all services being provided. Some aspects of these operations can be exceedingly complex, such as participant transportation upon arrival. Using participant transportation upon arrival at a meeting or other event as an example, typically the items that need to be tracked include transportation vehicles, driver gratuities, porterage costs, meet and greet operations, as well as many other “ground services.”. Participant departure transportation can include the same types of items, as well as adding the requirements for bag pull information, departure notices to participants, and other services necessary for successful handling of large groups of people. “Participant Departure Notices”, in particular, are a critical function in the meeting planning industry. Especially when handling large groups of people, it is imperative that all participants know the details of their respective departures. In addition, meeting planners need to keep track of costs, and when reselling by the meeting planner or other intermediary accountable to the meeting planner is involved, the sell prices of all services provided. This is particularly crucial when dealing with custom events created or operated by the meeting planner.

In addition to handling group participants and event scheduling, the meeting planner must also coordinate the services and/or products being purchased through various vendors. Group events can consist of an unlimited number of individual components, such as transportation, site rental, entertainment, table linens, activities and just about any other conceivable component to operate a successful event. These services or products are typically acquired through a system of Service Requests (“SRs”) or Request For Proposals “RFPs”). Generally all the details of the group program are handled by a variety of documentation and storage methods. Additionally, a majority of vendor offerings and costing/pricing information is stored in paper files. Correspondence with participants, clients (i.e., customers of a meeting planner), and vendors (i.e., sellers of goods and services consumed in a meeting or other group activity associated with a meeting) is generally accomplished using word processor documents that are mailed or faxed to the intended recipient. When correspondence is required that contains information stored in spreadsheets or other digital media, word processing mail merges or manual document generation are usually used to create these documents.

Currently, many aspects of the actions required to plan and operate a successful group meeting are accomplished in an disjointed manner through the use of individual word processors, spreadsheet programs, and contact databases, which results in a wide variety of meeting data being stored in a wide variety of formats and locations, much of which is duplicated. These methods, while they get the job done, are error-prone, provide no way of ensuring that common data is accurate from place to place, and are accessible only by particular individuals and locations. The issue becomes more significant during the actual operation of the meeting. Documentation needed to operate events and service individual participant needs is voluminous and once generated, it is difficult and time consuming to modify every copy of the documentation in use.

Actions necessary after the meeting has been accomplished typically consist of analysis of the meeting as a whole, as well as itemization and detailed breakdowns of the individual components of the meeting. This is necessary to reconcile billing, purchase, and financial obligations of individuals and organizations involved in the group meeting process.

The large players in the group meeting industry, typically the hotel chains, airlines, and convention centers, are extremely competitive and have, in recent years, attempted to reduce pricing and begun to target the end user directly to increase profit margins and remain competitive amongst themselves. As a result, there has been continued erosion of fees and commissions historically paid to middle tier group meeting service providers. There is increasingly a need for these providers to enable themselves to provide a wider variety of services and products to their clients and to operate in a more efficient and cost-effective manner. An improved meeting planning system would also take advantage of widespread Internet access to support meeting planning system access from multiple locations, including client business offices, meeting sites, and event sites.

Although there are a variety of on-line travel and planning services available on the Internet, they are typically of limited scope and completely on-line based, i.e., an Application Service Provider (“ASP”). ASPs, such as GetThere.com, of Menlo Park, Calif., and Event411.com, of Marina del Rey, Calif., do not provide any functionality unless an Internet connection is present and address only a single aspect of the operations needed to successfully plan and operate a group meeting. ASPs do not address the need of meeting planners to have complete access and control of all aspects of the group meeting. Most of ASPs have a policy that any data entered into their systems becomes the property of the ASP service provider. There is often sensitive information involved which corporations are reluctant to release to a third party for use in the operation of a group meeting.

### SUMMARY OF THE INVENTION

The Multi-nodal Meeting Planning System and Method (“MMPS” or “PLANITDIRECT™ System”) invention provides an innovative method for simultaneous use and updating of the data needed to plan and operate a group meeting, including comprehensive data access and standalone operation, in one or more primary locations and one or more remote locations by using a plurality of nodes in a distributed architecture, multi-node system that allows the users of the software, the client, vendors, and group participants in various locations to access and manipulate data simultaneously while assuring that the data set at a primary node remains accurate and up-to-date. Any changes and/or additions that are made at a remote node and updated on one primary node, and can then replicated to any other primary nodes. Security and confidentiality issues are addressed by the exporting only the information that the meeting planner or client deems appropriate for the operation of the group in the field environment. In addition, advantages are achieved because the group participants are able to access their individual bookings, review current reservations, modify or add to their selected activities on their own, without requiring the expense and scheduling of staff. The term “remote node” refers to any node other than a Local Node.

The system in its entirety consists of a combination of nodes and a distributed architecture that performs specific functions involved in the meeting planning and operation process. These nodes are:

“Local Node”, which is a node running the PLANITDIRECT™ “Meeting Planner” host application software and associated with at least one data repository;

“Remote Field Node”, which is a node running PLANITDIRECT™ application software and associated with a “Single Group Meeting Data Set” generated by the relevant Local Node;

“Resource Browser Node” or simply ‘Resource Browser”, which runs PLANITDIRECT™ application software and is accessed via any commercially available Web browser software, and contains vendor information and resources that can be employed by meeting planners, clients, and participants;

“Vendor Node”, which is a node running PLANITDIRECT™ application software and is the access point for vendors to populate the Resource Browser with their resources, services, and products and to confirm booked reservations generated by the Remote Node and is accessed by the Local Node, a Web browser interface, or a Vendor Version. “Vendor Version” is a version of the Meeting Planning software tailored to a vendor; and

“Remote Node” which is a Web server handling transactions, and is the host of PLANITDIRECT™ application software called “Live Meeting Web Site”.

The Remote Node coordinates communications amongst the various other nodes and processes reservations and purchase transactions which are then shared with the Local Node, Remote Field Node and Vendor Node. comprising a given implementation of an MMPS. Optionally, a “destination server node”, which handles a geographic region for a Remote Node” as well as redirection of destination specific Resource Browser information, can be used to locate the actual physical location of “Live Meeting Web Site” hosting to a server in close proximity to the location of the actual group meeting.

The invention also provides a method for accurate electronic booking, tracking and documentation of event and activity participation and payment. The process is centered around the features and capabilities of the PLANITDIRECT™ System, a destination and reservation management system which is designed to handle all aspects of group travel planning and implementation and which can interface with a remote Internet server to generate a variety of specifically targeted and accessed e-commerce and participant registration web sites for use by selected participants, clients, or resellers. One of the key features is direct payment to vendors via transaction servers operated by the PLANITDIRECT™ System. This allows vendors to offer events and activities at reduced pricing to selected purchasers by eliminating the mark-ups generally added by resellers, though resellers can benefit from the system as well. The intention of this invention is to provide a method for interactive sharing of information between vendors of events, activities and products and those who purchase them.

This information can include, but is not limited to:

Resources and Vendors providing resources necessary for the assembly of a group meeting;

Participant names and contact information relevant to implementation of the group meeting;

Dates, times and other schedule information related to booked activities or events;

Specific details regarding the activities or events such as driving instructions;

Contact information for clients, intermediaries or resellers purchasing the activities;

Participant grouping information;

Financial data regarding the purchased activities;

Changes, additions or cancellations of activities; and

Transaction processing, either direct to seller or through an intermediary.

The PLANITDIRECT™ System provides a single interface to a meeting planner or person otherwise involved in group or individual travel to access and build a comprehensive itinerary of events and available activities for participants of the designated group of people traveling. The system is designed around the central concept of managing a group of people for a specified length of time at a particular destination or destinations. The system allows the user to build groups and events by utilizing a concept called “Resources”. These resources can be anything from a 8 hour private charter fishing boat to filigree doily sets for a table setting of 2000 to a 50 passenger minibus used to transport a group of people. These resources can be loaded in by hand, imported via “data sets” or obtained through the net via the Resource Browser. The user can use the system to peruse the resources available in a particular destination and then choose to store selected resource for local use and availability to all users or just utilize that resource for a particular group. When the resource is transferred to the Local Node, it can then be adjusted, modified and customized to suit the needs of the particular planner or group meeting requirements.

### BRIEF DESCRIPTION OF THE DRAWINGS

FIG. 1 is a diagram of the system architecture containing embodiments of the invention.

FIG. 2 is a table of the steps used in the shared remote data real-time update system.

FIG. 3 illustrates the services provided by, and the interaction among, a Local Node, a Remote Node, a Remote Field Node, a Resource Browser, and.

FIG. 4 illustrates the services provided by, and the interaction among, a Resource Browser, a Vendor Node, a Remote Field Node, and a Local Node.

FIG. 5 illustrates the services provided by, and the interaction among, a Vendor Node, a Resource Browser, and a Remote Node.

FIG. 6 illustrates the services provided by, and the interaction among, a Remote Node, a Vendor Node, a Remote Field Node, and a Local Node.

### DETAILED DESCRIPTION OF THE PREFERRED EMBODIMENTS

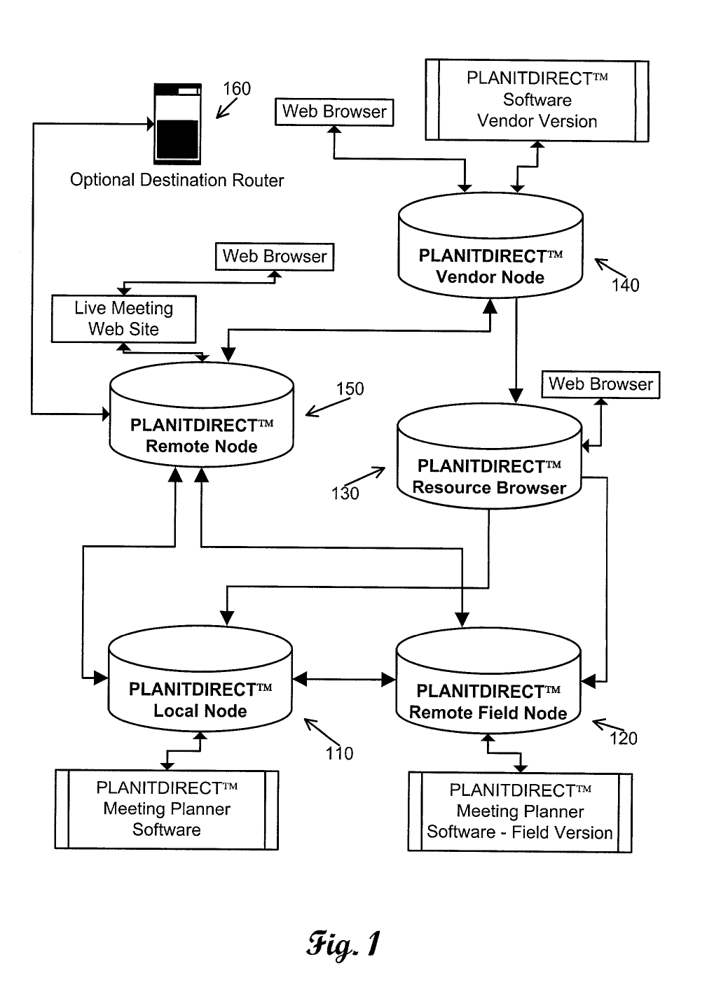

As shown in FIG. 1, the Local Node (110) consists of the PLANITDIRECT™ System Meeting Planning software that allows the planner who is creating or coordinating a group program to have access to all the pieces required to assemble a successful group program. This software interfaces with all the other aspects of the PLANITDIRECT™ System and serves as a cohesive location where decisions can be made, reports can be generated, details can be tracked and financial information can be evaluated. Communications between the various nodes of the system are accomplished in a variety of ways. Most routine operations between the Remote Field nodes are accomplished by using encrypted and signed e-mail messages through a dedicated e-mail server integrated into the Remote Node (150) which process the requests submitted to it via those messages and returns either a set of data that was requested or a confirmation that a specific instruction was successfully implemented. For instance, if a Remote Field Node (120) sends a request for all new participant records, the Remote Node responds with an encrypted, signed message containing the requested data back to the originating Remote Field Node (120). If a Remote Field Node sends a request that does not require data return, such as an instruction to mark a particular record as having been read by that particular Remote Field Node, the Remote Node sends back a message that simply states that the instruction has been successfully implemented.

There are times, however, when instantaneous communications are required between the various Nodes of the system. When this is the case, communications and data transfer occurs via a secure HTTP connection which allows each node to communicate directly with the Remote Node to obtain information as necessary.

In addition, the system is designed to orient around the messages being transmitted and are not limited to the two communications methods denoted above. Future means of communications will function in the same way and will in no way change the operational premise of the PLANITDIRECT™ System.

The system in its entirety consists of a combination of nodes and a distributed architecture that performs specific functions involved in the meeting planning and operation process. These nodes are:

“Local Node” (110), which is a node running the PLANITDIRECT™ “Meeting Planner” host application software and associated with at least one data repository;

“Remote Field Node” (120), which is a node running PLANITDIRECT™ application software and associated with a “Single Group Meeting Data Set” generated by the relevant Local Node;

“Resource Browser Node” (130) or simply ‘Resource Browser”, which runs PLANITDIRECT™ application software and is accessed via any commercially available Web browser software, and contains vendor information and resources that can be employed by meeting planners, clients, and participants;

“Vendor Node” (140), which is a node running PLANITDIRECT™ application software and is the access point for vendors to populate the Resource Browser with their resources, services, and products and to confirm booked reservations generated by the Remote Node and is accessed by the Local Node, a Web browser interface, or a Vendor Version. “Vendor Version” is a version of the Meeting Planning software tailored to a vendor; and

“Remote Node” (150) which is a Web server handling transactions, and is the host of PLANITDIRECT™ application software called “Live Meeting Web Site”.

Shared Remote Data Real-time Update System.

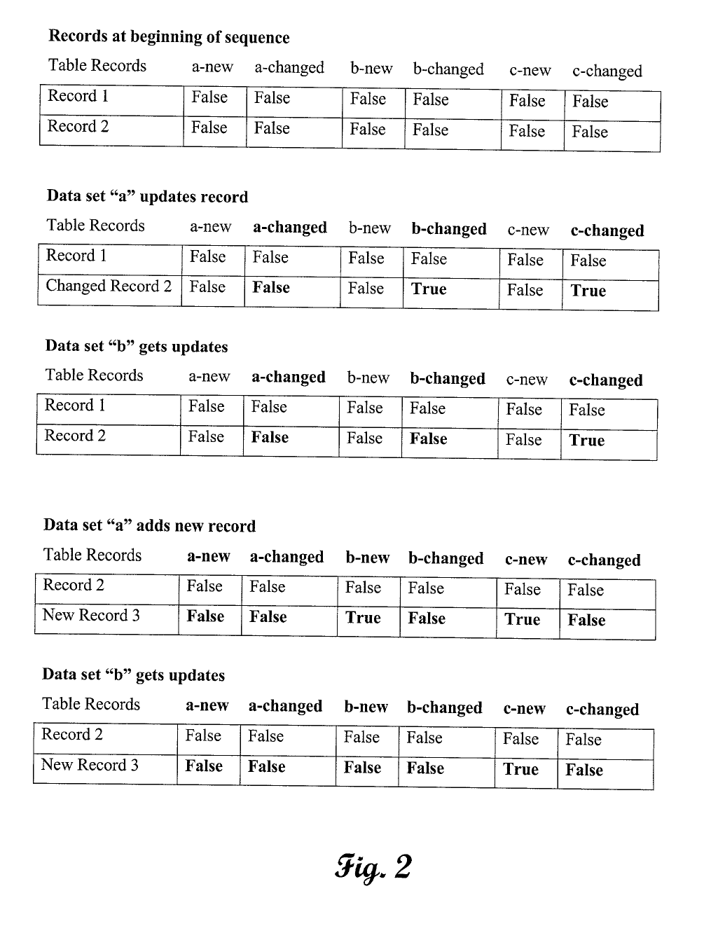

As shown in FIG. 2, data located in field databases, remote field nodes and main databases are kept up-to-date with each other via a means of fields in tables located on a designated Remote Node. This is accomplished by including a set of two fields in each table for each copy of the group data set designated as x-New and x-Changed, both being Boolean fields (True/False) where the x indicates a letter assigned to a particular data set.

Whenever changes are made to the data in a particular record in a data set, the Remote Node is notified of the update to the particular record in the particular table. When this is an update, the “changed” field for a particular record in a particular table corresponding to the data set that initiated the change is marked as False. All other “changed” fields corresponding to all other data sets are marked True. In the event that the action performed by the data set involves the addition of a new record, then the “New” field in the particular table and the particular record corresponding to the generating data set is marked False. All other “New” fields in the particular tables for the particular records corresponding to all the other data sets is marked as True.

This results in a particular record in a particular table on the Remote Node now having been set as not being new, or not being changed, as the case may be, by the originating data set, but being set as New, or changed as the case may be, by all other data sets.

Each data set then, periodically (length of period set by user, typically every 5 minutes), queries the Remote Node for any records in a particular table whose corresponding “New” field is set to True. The data set then adds the record to its own tables. Once this has been successfully accomplished, the data set directs the Remote Node to now mark its corresponding “New” and “Changed” fields for a particular record in a particular table to false so that the next time the query is run, the Remote Node does not send back a record that has already been processed by a particular data set. A comparable process occurs for changed records using the data set's corresponding “Changed” fields. This system allows for the intermittent failure of communications between the various nodes of the system without affecting the ability of each node to update its own records as it is able to.

PLANITDIRECT™ System Meeting Planner (Local Node).

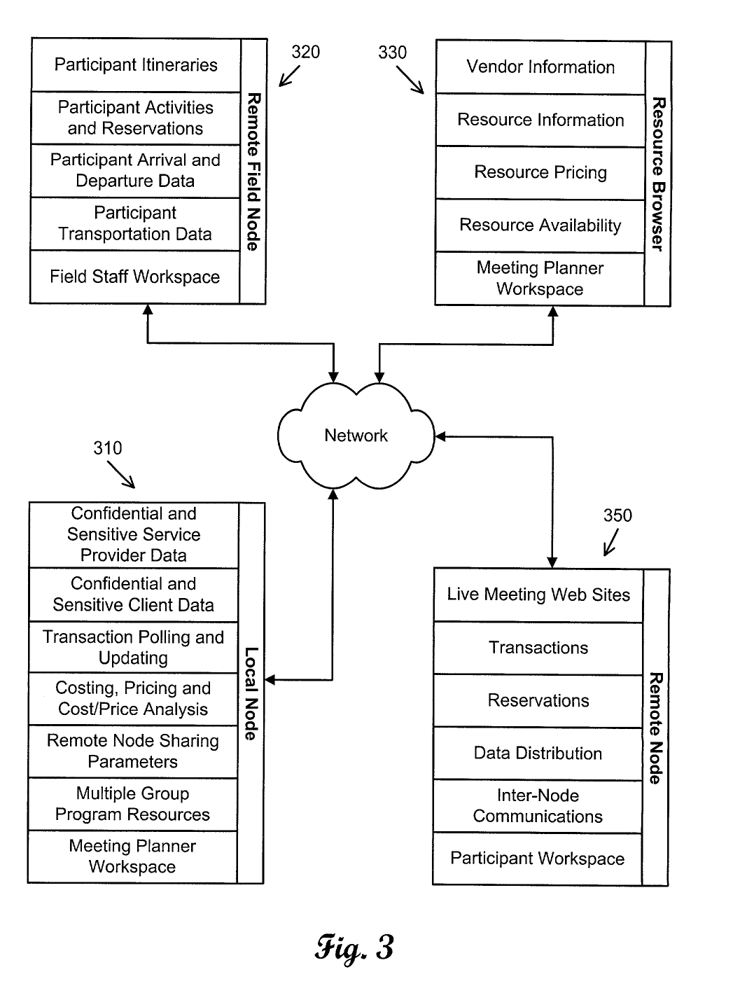

As shown in FIG. 3, the Local Node (310) contains all of the information required for a group in a central data repository that contains all of the data for all groups being handled by the meeting planner. This includes, but is not limited to: Client, Contact, Association and Employee Data; Group Start/End Dates, Group Location, Default Airport, Default Hotel, Activities, Group Events, Transportation Information, Participant Travel Data, Staffing Schedules, Main Resources, Group Resources and all other data needing to be tracked, manipulated or accessed for the successful operation of a group.

The Local Node (310) is typically located on an individual PC, a secure LAN or a company LAN and is not accessible to the general population. The local administrator of the system upon which the Local Node is located defines access control. Individuals designated as having permission to access the compiled information may import individual sets of data into the Local Node from a variety of sources to accommodate the cohesive access of all group data. The Local Node replicates individual group meeting data sets as well as all related information to a particular group meeting for use in the field, typically on laptop computers via a LAN. These replicated data sets then become Remote Field Nodes (320). Additionally, the Local Node controls what information is to be sent or made available to the Remote Node based upon user settings. The Local Node updates the main data set via a polling system or real-time updates depending upon the type of remote node implemented for a particular group. These methods are described in the above section, Shared Remote Data Real-Time Update System.

Remote Field Node Export/Import Process.

In the group travel industry on-site activity sales occur through the use of on-site personnel handling booking and manual ticketing which must then be brought back to the main office and manually introduced to either in-house meeting planning software or to in-house accounting software. In-House meeting software may be either purchased software designed for meeting planner activities or may be as simple as a table or spreadsheet that allows for minimal data manipulation.

The invention described herein consists of a Remote Field Node export and re-assimilation process. This allows the use of PLANITDIRECT™ Meeting Planning software designed to be in operation at the actual group event location and immediate access to cost/price reports and logistics documentation needed for the handling of group event happenings.

The home office software (Local Node) is a repository for all the details that need to be handled for all group events being addressed by the meeting planner. The concept of a field data set consists of the action of assembling the information pertaining to a particular group in its entirety and exporting that information to a remote location for use by staff in the field. Typically this is done over a LAN to a laptop computer or through a Virtual Private Network (“VPN”).

The information sent out encompasses all data previously entered and needed to coordinate the logistics of handling a particular group of Participants. This may include transportation movements, individual activity bookings, event scheduling, staff scheduling, participant accommodations, group resources and client communications histories as well as any other information necessary for the successful operations of a group.

The process consists of a multi-step process:

Creation of a blank data set container at a location selected by the user;

Assignment of an Identifying Letter which is then used in the Remote Node for identification;

Transfer of data to the blank data set container in a particular order to assure that relationships required by relational database techniques are adhered to. For example: The main group cannot be created before the client contact information because the group is dependent on the contact ID number to maintain data integrity and to identify which client a particular group belongs to;

Marking all records in the exported data set as having been current as of the time and date of export;

Addition of fields in tables on Remote Node that will be used to track changes and additions of this particular data set;

Marking of all records in Remote Node tables that exist at the time of export as having been read by the particular Remote Field Node;

Exporting a copy of the Front End software that is aware of the fact that the data is contained in a field data set;

Export of user information and security access levels;

Export of all documents contained in the folder associated with the group for access in the field.

Remote Field Data Set access at the group location;

Import of the Field Data Set to temporary tables in the Main Data Set;

Updating of all records in main Data Set to reflect records marked changed in field data set that have not been previously communicated to the Local Node via the data communications system in use by the Remote node; and

Addition to the main data set with all records marked new in the field data set. This is done in a particular order to adhere to the requirements for data integrity in a relational database environment.

Local File Directory Associations.

The PLANITDIRECT™ System Meeting Planning software allows access to designated local storage media at the click of a button. Contact records, Employee, Association and Group records can be associated with a particular folder located on a local hard drive or through a local network.

The association of particular pieces of data with a locally accessible file storage device allows for the automatic saving of documents in a particular common location when they are generated by the software. These documents may consist of word processing documents, flat-file database files, and static report “snapshots”. The selected folders are then easily accessible from within the software at the click of a button.

Contact, Employee and Association Pools for use in Groups.

The PLANITDIRECT™ System Meeting Planner software provides a common repository for the storage of contact information for Clients, Vendors, Suppliers, Employees, and Associations that can be used repeatedly to generate group participant lists as well as a comprehensive contact history record.

The software contact management section contains three distinct storage locations: Contacts, Employees, and Associations. Any of these can be used to populate the participants in a particular group. This is accomplished by selecting individual contacts based on a set of criteria or manually selecting contacts by use of a check-box system. Once the set of contacts has been determined, they may then be sent to a particular group meeting for inclusion in the participant lists for that group.

About Company-Vendor Data Details Availability.

The PLANITDIRECT™ System Meeting Planner software provides a method of accessing detailed vendor and product information electronically without have to physically locate the information needed.

The software stores vendor company and detail information in a format that is accessible from a variety of places in the group program areas as well as the contact management areas of the software. A small text/graphics box is displayed in these areas that, when double-clicked, launches a detailed company information document in a popup viewer. This document may have services provided, contact information, pricing information, as well as a means to obtain additional information about this company (such as a World Wide Web link).

Group Participant Departure Notices.

The PLANITDIRECT™ System Meeting Planner software provides methods to generate comprehensive departure information to be furnished to group meeting participants.

Details: The critical task of providing accurate and helpful departure notices to departing group participants is accomplished by generating departure notices based on participant departure data. Participants are grouped together based on their hotel, hotel room number, hotel depart time and departure airport. Different departure notices can be automatically generated by the software for different requirements. For instance: a participant with a rental car does not need to have the same information as a participant for which the meeting planner is providing transportation to the airport for departure. Some participants may require bell assistance, while others may handle their baggage on their own. Using specific criteria (known in the software as Participant Selection Sets or PSS) the software can selectively generate a departure notice for each individual participant. Participants without required information are automatically excluded from the Departure Notice Generation Process. An unlimited number of Departure Notice templates are available to be created by the software user. Additionally, the Departure Notices themselves are customizable and have the ability to adjust such aspects as header space of footer space to accommodate company letterhead.

In addition, this departure information can be accessed via the Live Meeting Web Site located on the Remote Node which is accessible to the participant via a Web Browser.

An example of a notice prepared for a group departure from a hotel would be:

Hotel Depart Date: Friday, Sep. 14, 2001 Room #: OU1051

Name: Einstein, Albert

Einstein, Elsa

Aloha,

In order to assist you with your departure from Maui, please follow these simple instructions as you prepare to leave the Four Seasons Maui. In the event that the information contained in this notice does not match your airline ticket, please contact your travel staff representative as soon as possible in order to make any necessary corrections.

Please have your bags packed and ready for a Bellman to pick them up outside the door of your room by 3:24 p.m. Also, make sure each bag has a clearly defined luggage tag attached for identification purposes.

Your luggage will be brought to the Silversword Room for storage until your departure later in the evening.

Changing rooms will be available throughout the day. Please see Steve in the Silversword Room for the keys.

Transportation has been arranged to take you to Kahului airport for your Aloha Airlines flight number 1036 departing at 5:24 p.m.

Both you and your luggage are scheduled to depart the Hotel at 4:24 p.m. from the Four Season's group entrance.

Please allow ample time for your Hotel checkout process and to take care of any incidentals before leaving the property. We also ask that you personally identify your luggage at the group entrance to ensure that it has all been properly delivered. As always, we recommend that valuables be kept on your person or in carry-on luggage held in your possession while traveling.

All departing mainland passengers must have their checked luggage pass through the airport's Agricultural Inspection Station before being brought to the ticket counter.

PLEASE REFRAIN FROM PACKING ANY FRUITS OR PLANTS THAT HAVE NOT BEEN INSPECTED AND APPROVED FOR TRAVEL. THEY WILL NOT BE ALLOWED TO TRAVEL WITH YOU.

Each passenger must show a picture identification when checking in for his or her flight. Please remember to have your identification or passport ready to expedite your check-in process.

We wish you a pleasant journey. It has been a pleasure to serve you.

Group Participant Personal Itinerary.

The PLANITDIRECT™ System Meeting Planning software provides a single repository of schedule information for each group participant. Comprehensive itineraries can be generated which include all schedule related information pertaining to a particular group participant.

Because all schedule related information pertaining to individual group participants is available to the user, it is a straightforward process to generate comprehensive itineraries for group participants which include everything from arrival flight information, activity schedules, events which to which the participant has subscribed, hotel departure information and departure flight information. This personalized participant itinerary can then be distributed to each participant via printed page or through electronic media.

In addition, this itinerary can be accessed via the Live Meeting Web Site located on the Remote Node which is accessible to the participant via a Web Browser.

Multiple Sell Types for Events.

One of the key services provided by a meeting planner is the creation of a custom event for a group. These events typically consist of a multitude of components such as transportation, activities, catering, entertainment and a variety of others. Usually these events are paid for by the group client at either a bulk sell price or a fixed mark-up of each component of the event and all group participants have free access to these events. Occasionally, the event will be designed to have the actual participants pay for their entry into a particular event. Currently, there is not a method for easily accomplishing this.

The PLANITDIRECT™ System Meeting Planner software provides a method to perform comparisons of various sell types for a group event that can be viewed on the fly.

The Event module of the software incorporates the ability to select which sell type is to be used to determine income generated for a particular event. These three options are:

Per Component: This method allows for the markup of each and every component in the event. Individual markup rates can be set for each event component;

Bulk: This method allows the user to designate a bulk sell price which is independent of the individual components of the event consists; and

As Activity: This sell method allows the user to designate an event to be sold as an activity. The user sets the sell price and details such as special instructions or check-in locations. The event then behaves as an activity and is available to all participants in the participant activity section of the software. The participant does not see a difference in these types of activities from the standard activities already listed as available.

The three sell types can be viewed as the user desires for comparison purposes without affecting the sold as activities entries which have already been booked. In addition, any one of these methods can be configured to be treated as a “Hosted” event which means that there is no cost to the individual participant for entry, regardless of which method is used to pay for the event as a whole.

Multiple Cost and Sell Types in Event Component Details.

Events consist of a multitude of components which range from transportation to staffing to activities to table linens to entertainers. The complexities of purchasing and reselling these individual components can be daunting to an individual. There are issues such as vendor guarantees (where the vendor is guaranteed that a certain number of purchases will be made for this event and requires payment of that minimum regardless of actual use), client guarantees (where the client agrees to pay for a minimum number of purchases regardless of the quantities actually used) and bulk purchases (single fee for all being purchased) and bulk sell (Single sell price to client for an individual component).

The PLANITDIRECT™ System Meeting Planning software allows the user to select a combination of costs (vendor guarantee, bulk purchase or actual use) and a combination of sell pricing (client guarantee, bulk sell price, actual use).

The selection of any of the above defined possible cost and sell methods affects the profit generated for a particular component. The user of the software is able to view the results of any combination with the simple selection of one of three cost types and one of three sell types to determine the most advantageous methods to be used for cost and sell.

Group Participant Transportation Groupings.

One of the most visible aspects of servicing a group is the transportation of group participants when they arrive at the group destination, when they depart and to and from events that are part of the group program. These transportation movements generally consist primarily of the procurement of vehicles to perform the actual transport operation. In addition, there are many other elements of a transportation movement. These can include, but are not limited to: driver gratuities, additional porterage costs, meet and greet operations as well as a variety of other services that may be specific to a particular destination. In the case of arrival movements there are generally 2 types: participants who are being transported (referred to as transfers) and participants who may have rental cars reserved and therefore do not need transportation (referred to as “RAC”). Because greeting services are often involved, the transportation movements need to address all participants, regardless of whether actual transportation is being provided. Costs associated with the vendor providing the actual vehicles for transport are considered to be internal costs for the movement. Costs associated with the movement but which are paid out to different vendors are designated external costs. These consist of items like gratuities, meet and greet, and other services provided by vendors other than the transportation vendor.

The PLANITDIRECT™ System Meeting Planning software provides a sophisticated method of handling groups of participants by using groupings based on common criteria. The transportation portion of the software groups participants according to their arrival or departure data for ease of use. Two types of transportation movements using this technique are arrivals and departures.

Arrivals.

In the case of participant arrivals, the software groups participants based on their Arrival Date, Arrival Time, Arrival Airport, Arrival Airline, Arrival Flight Number, Which hotel or resort they will be staying at and the type of arrival (standard, VIP, etc.). The type of arrival selection is made on the individual participants arrival data screen and allows for the use of separate movements for participants with identical arrival information. The user adds the relevant flight groupings in the transportation movement that automatically adjusts the transfer, RAC and total participant totals based on the flights selected. By default, arrival movements will not allow multiple flights to be selected if they do not have the same hotel listed (known as the Drop-Off location). This action can be overridden by the user to allow for the use of a single vehicle to transport participants arriving together and having Drop-Off locations in close proximity to each other allowing the user to realize cost savings by combining transfers to Drop-Off locations in the same physical region. The end result is a system that is capable of generating documentation detailing all aspects of an arrival transportation movement.

Departures.

In the case of participant departures, the software groups participants based on their Departure Date, Departure Hotel, Hotel Departure Time, Departure Airport, Departure Airline, Departure Flight Number and the type of departure (standard, VIP, etc.). The type of departure selection is made on the individual participants departure data screen and allows for the use of separate movements for participants with identical departure information. The user adds the relevant flight groupings in the transportation movement that automatically adjusts the transfer, RAC and total participant totals based on the groupings selected. By default, departure movements will not allow multiple hotel departures to be selected if they do not have the same hotel listed (known as the Pick-Up location). This action can be overridden by the user to allow for the use of a single vehicle to transport participants departing together and having Pick-Up locations in close proximity to each other allowing the user to realize cost savings by combining transfers from Pick-Up locations in the same physical region. The end result is a system that is capable of generating documentation detailing all aspects of a departure transportation movement.

Transportation Driver Gratuities Calculation.

Transportation Movement Driver Gratuities can be calculated using one of two methods: A flat amount per vehicle or A per participant amount. The software performs comparisons and selects the appropriate gratuity for a particular movement.

Transportation vehicle resource types have an option to set a minimum per vehicle gratuity amount and a per participant gratuity amount. When vehicles are selected for a particular movement, the user either accepts the preset values or selects a gratuity amount for each participant and a minimum gratuity amount per vehicle. As flights are added and transfer counts are adjusted, the software calculates the amounts per participant and compares that amount to the minimum per vehicle and adjusts the gratuity for the movement to the higher of the two amounts.

Transportation External Costs Automation.

Costs during the implementation of transportation movements are frequently incurred through a variety of service and product providers. The PLANITDIRECT™ System Meeting Planning software uses automation routines to adjust and calculate individual costs based on group participant arrival and departure data. These routines apply to porterage costs and meet and greet operations.

Each group has a user selectable entry that determines whether automatic calculation of meet and greet or porterage will be used. Additionally, a per participant amount, as well as whether transferred participants only or all participants in a movement are affected, is selected. As flights are added to a particular movement, the software performs the following operations:

Checks to see if the user has elected to have automated calculations for these items performed. If no the software returns control to the user. Otherwise, it continues on to calculations;

Checks the amount set to be used for each participant;

Checks which calculations method is to be used: Transfers Only or All Participants; Calculates totals based on previous entries and number of participants entered into the transportation movement. Enters these into the movement fields provided for this purpose; and

Adds all movement costs including internal and external costs for a total movement cost and sell and displays the results to the user.

Transportation Services Auto-Calculation.

Additional services provided by the transportation vehicle vendor are applicable to either movement transfer count or total movement participant counts.

In addition to external costs, transportation movement vehicle vendors may also be providing services for the movement. Typically these consist of things like golf bag transport fees as well as any other service provided by the vendor that are based on participant counts. Transportation service resource types have an option to set a per participant amount and a calculation type of either Transfers Only or All Participants. When services are selected for a particular movement, the user either accepts the preset values or modifies the amounts and calculation types for each service being provided. As participant and transfer counts are changed, the following operations occur:

Checks to see if any services are set to have automated calculations performed. If no the returns control to the user. Otherwise, continues on to calculations;

Checks the amount set to be used for each participant;

Checks which calculations method is to be used: Transfers Only or All Participants;

Calculates totals based on previous entries and number of participants entered into the transportation movement. Adjusts the quantities in each service entry to reflect the appropriate calculated amounts; and

Adds all movement costs including internal and external costs for a total movement cost and sell and displays the results to the user.

Service Requests.

Service Requests or Requests For Proposals are generated by the group meeting planner to order products or services necessary for the successful operation of a group program. These also serve to check for the availability of a particular service on a particular day and time.

Methods to generate Service Requests and track what has been submitted as well as when, by whom and whether subsequent submittals are revised versions of previously submitted service requests or new requests for products or services.

When generating a service request from anywhere in the software, several actions take place:

The user is prompted for information to be contained in the generated document such as confirmation information, special notes to the targeted vendor and whether or not additional details are to be included such as individual participant names or just total counts involved for the services being requested;

The software checks to see whether a service request has been previously generated for the service or product being requested. If it has been previously generated, the appropriate sections are designated as “Revised” and text indicating this fact is incorporated into the header of the particular service in question;

Once the user has reviewed the service request for accuracy and elects to follow through on the document generation, the software saves a static viewable copy of the service request in the local folder associated with the group and completes sending of the request either though printing for fax, fax directly or submittal through other electronic means;

An entry is made into the particular section of the group that has generated the service request documenting the details of the submittal and as well as an entry into the overall group service request log; and

The particular transaction or transaction which are being addressed in the service request are marked as having been submitted. This allows for the software to determine that a service request has been generated and allows the software to determine whether subsequent submissions for the same services or products are to be labeled “Revised”.

Service Request Logs.

Service Requests (“SRs”) or Request For Proposals (“RFPs”) are submitted for all services or products required to implement a successful group meeting program. These items must be tracked and documented throughout the group program duration. This is especially necessary for reconciliation of transactions initiated by the group after the group program is completed.

The PLANITDIRECT™ System provides each group meeting program with a Service Request Log that is used to track and document SR activity for the duration of the group program. This log has data posted to it whenever a service request is generated from anywhere in the group program. Information posted includes the following:

The vendor and/or vendor contact to which the SR was submitted;

The user logged into the software when the SR was generated;

Date and time of SR generation;

Whether the SR was a new or a revised submittal;

Any confirmation information entered into the software;

What section of the group program the SR was generated for (transportation, events, golf event, etc.); and

Whether the SR was generated in the main office node or in a Remote Field Node.

Electronic Purchase Confirmation and Vouchers.

The PLANITDIRECT™ System provides real-time activity booking confirmations, receipts and vouchers. The software uses e-mail functions to provide the group participant purchasing an activity with an immediate confirmation of booking, receipt, and printable voucher for use when attending the booked activity. This eliminates the need for staffing to interact with each and every participant and significantly reduces the labor costs involved when servicing a large group. Activities and events purchased or registered via the Live Meeting Web Site may receive electronic confirmations or vouchers at the discretion of the group meeting planner. This is decided by the user settings for the particular group meeting in the PLANITDIRECT™ System Meeting Planner software.

PLANITDIRECT™ System Web Transaction Builder. The web transaction builder is a component of the Web Site Builder which determines what specific transactions are available to the Live Meeting Web Site. The transaction builder consists of tools used to build individual transaction which are then interpreted bt the Live Meeting Web Site and displayed as a sequence of selections which are then activated by clicking on an HTML “Submit” form button. In addition to the main transaction, an activity sale for example, the transaction builder can also incorporate additional options to be processed along with the primary transaction. These options can be displayed in the form of:

Pull-Down Lists;

Text Entry Fields;;

Date/Time Fields;

Check-Boxes; and

Radio Buttons.

For instance, a primary transaction may consist of the sale of a helicopter tour. Associated options may consist of date/time selections, Check-Boxes indicating the desire for a tour video, text fields for inclusion of passenger weights and radio buttons selecting whether each person desires a front seat or back seat for the tour. The Web Transaction Builder also determines what is done with the transaction when it is brought into the PLANITDIRECT™ System Meeting Planning software from the Remote Node. Using the above mentioned example, the Web Transaction Builder may be set to perform up to two operation for each primary transaction and each option. These may be one of the following:

Enter activity purchase into individual sales tables;

Enter date or time preferences into individual activity tables;

Enter returned option into comment field of an activity sales entry;

Enter participant into top level Event or Event Component manifest;

Enter data into a particular field in either top level or component level Event Manifest;

Make entry into comment field of either manifest;

Add notation to comment field provided for each participant; and

Update overall count for event or event component level “Actual” participant count.

These actions occur when the transaction is brought in to the PLANITDIRECT™ System Meeting Planning software or, at the discretion of the user, may be delayed until the user manually elects to confirm a transaction, after which the aforementioned processes occur.

PLANITDIRECT™ System Web Builder.

The web site builder takes information entered by the user and informs the Remote Node about the parameters and contents of the Live Meeting Web Site base on the particular details of a group program. The user selects the following information for the web site:

Overall details such as the name of the group program, the location of the web site, the color scheme and/or style to use for the web site, group logo or graphic, major categories for the pages to be built (these are used to build a navigation menu in the web site) and other overall look and feel selections;

Additional details for the web site such as access settings, whether a single password will be used to access or whether individual passwords for participants will be required, whether participants will be able to change their arrival/departure information, whether participants will be able to enter their own personal entries for an itinerary, whether higher level access is allowed for administration purposes, etc.;

Which participant names and details are to be sent to the web site? For instance, a user may choose to only allow primary participants to have access and not guests or may want to have all participants to have access to the web site; and

The contents of individual web pages and which Web Transactions are to be used in which pages.

This includes, but is not limited to special fields which are replaced by the Remote Node with actual content such as participant information, group information, and special fields such as email message indicator and notice of announcement indicators. The contents can consist of text, pictures, tables and any other HTML allowable content.

In addition, purely “static” informational web pages can be included and uploaded to the Remote Node. A group program itinerary can also be built and included in the web site; this is optional and is generated at the user end by the PLANITDIRECT™ System Meeting Planning software. Additionally, individual participant itineraries can be made available to the participant by utilizing the special fields to customize the HTML document for the logged-in participant.

The Web Builder also determines, at the discretion of the user, which menus and pages are available for each. Participant logged into the Live Meeting Web Site. These can be selected individually or based on common criteria by the planner using the PLANITDIRECT™ System Meeting Planning software and allow for the ability to allow access to particular pages and areas of the Live Meeting Web Site. This allows the planner to set up particular pages which are oriented towards staff, for instance.

Transaction Services.

There are two methods of financial transactions. The PLANITDIRECT™ System Meeting Planning software user can select the option that best serves them.

Optional events/Activities sold via a Live Meeting Web Site for those planners on a “referral fee basis” (which would typically be most out-of-town planning companies that bring groups to a particular destination), the moneys for each sale would be delivered directly to the vendor via the PLANITDIRECT™ Remote Node to improve upon their (the vendor's) cash flow. The vendor would then be automatically (via built-in PLANITDIRECT™ System Meeting Planning software Web Builder features) invoiced by the planner at the end of the program for their commission or referral fee check based on PLANITDIRECT™ System reports generated by the Remote Node. The planner and his/her on-site staff is still able to assist their individual participant at the group's hospitality desk except they would not be responsible for handling any actual financial transactions.

Direct Electronic Sales.

The operator of the MMPS would debit their (the vendor's) preferred credit card account for each month's transaction fee. For example this would be 1.5% on optional sales and 0.50 cents per event/activity name on a manifest generated via the Live Meeting Web Site. The transaction fee would apply whether a financial transaction or event is cancelled or not. This method is best for the vendor as it provides strong cash-flow and allows the vendor to bypass the middleman that typically can collect anywhere from 20% to 30% or more in commissions in addition to taking 30, 60 or 90 days or more to pay their bill. The vendor in turn, can justify supplying the end purchaser with a discounted rate from the normal published rate for that group and still come out ahead. This method would require placing the vendor's telephone number and address on the e-ticket in the event that the user must cancel or is cancelled for any reason from their activity. They (the user or their on-site staff) will work directly with the vendor for their applicable credit card credit.

Reseller of Activities/events.

For the legal reseller planner (usually located locally to the vendor in the same state for permit licensing reasons etc.) that has been granted credit by the vendor, their option would be to have all of the financial transactions via the Live meeting Web Site, be paid to their account and both the PLANITDIRECT™ System and the vendor collect their moneys from the planner. In the PLANITDIRECT™ Systems case the planner would fill out a PLANITDIRECT™ e-credit form and provide PLANITDIRECT™ with their preferred credit card. PLANITDIRECT™ would then proceed to debit that account on a bi-weekly or monthly basis per the sales transaction information recorded on the Remote Node for that account. The vendor would invoice the planner accordingly per their personal agreement. PLANITDIRECT™ would activate a Resource Browser Vendor account so that vendors can load their own information and pricing etc. for uploading into the Resource Browser interface.

E-commerce Sales for Non-hosted Events and Activities.

Planners wishing to utilize existing (known to them) vendors via a Live Meeting Web Site for their group meetings, would be provided with a PLANITDIRECT™ System e-form that would upon being filled out, then be sent automatically to the vendor notifying them that the vendor is featured on a PLANITDIRECT™ System Live Meeting Web Site and that they should expect reservations to be made and sent to them from the Live Meeting Web Site. A planner with a (known to them) vendor can easily have prearranged pricing structured within their PLANITDIRECT™ Vendor Node.

External Transaction Processing.

Transactions such as activity sales to individuals, accommodations, event sales and event booking can occur external to the PLANITDIRECT™ System Meeting Planning software. Examples would be transactions effected on a independent web site, through a spreadsheet, or handheld electronic device. These transactions can be brought into the group via a method of comparing the transaction type to transaction identification tables which in turn identifies what action needs to be taken by the DSI Software Front End (“SFE”). Possible actions are:

Straightforward sale of an activity or event sold as activity that is added to the participant's activity sales table;

Booking of an event and addition of the participant to the overall event manifest;

Booking of a slot in an event component and addition of the participant to that particular event component manifest;

Booking of an accommodation which is added to the participants accommodations table; and

Entry of a booking into an event or activity manifest.

Events as Objects.

Events as used in the DSI SFE can be imported and exported to and from a stand-alone file. This file contains all of the information normally associated with an event including but is not limited to:

Event Details:

Event name and description; and

How event is sold;

Bulk: Entire event is sold at a single price:

By Component: The event is sold based on sell prices determined by each and every component of the event; or

As Activity: The event is sold at a pre-determined price to individuals;

Information describing the event which can be used to generate documents, brochures and web sites;

Images associated with the event which can be used to generate documents, brochures and web sites;

Information regarding the original resources used to build the event;

What components the event consists of (three types):

Transportation: Transportation components consist of all aspects of the event that involve the movement of people or goods. These components include but are not limited to:

Who is providing the services/vehicles;

What services/vehicles are being provided;

Tracking of gratuities;

Tracking of porterage;

Generation of Service Requests for transportation services; and

Detailed scheduling information including start and end times with descriptions;

Staffing: Staffing and labor components consist of all aspects of staffing for an event including, but not limited to:

Identification of the staff involved;

Descriptions of staff duties and assignments;

Cost and sell information and increments (hours, days, other increments);

Staff scheduling; and

Assigned locations for staff;

Event Component: These components consist of all other portions of an event that does not fall under the Transportation and Staffing category. Information for the components consist of, but are not limited to:

Who is providing the services/products in the particular component;

What services/products are being provided;

Cost information for the component including how costs are calculated whether by actual use, bulk cost or a vendor guaranteed qty as well as gratuity costs;

Sell information for the component including how sell prices are calculated whether by actual use, bulk sell or a client guaranteed qty as well as tax rates and gratuities;

Manifest information such as whether a participant manifest is generated for the overall event, the individual components or a combination of the two; and

Service request information including whom to send the request to, any schedule information required and any inclusions associated with the component.

Remote Field Node.

The Remote Field Node is generated by the PLANITDIRECT™ System Meeting Planner software and duplicates all of its capabilities, but is designed to be more portable, contains only the data necessary to operate a single group meeting and addresses the needs of actually implementing the operations of a group program at its location. This aspect of the system allows the personnel actually operating a group program in the field to access and modify all aspects of the group program. A group program is not limited to a single Remote Field Node for a group meeting program. As many copies as necessary may be generated, each with its own identifier for distinct communications with the Remote Node. The Remote Field Node software interfaces with both the Remote Node and the Meeting Planning software to allow all aspects of the group operations to be kept up to date by every portion of the PLANITDIRECT™ System. This includes the remote group planner, the vendors involved and other Remote Node software users for a particular group. The software is designed to be stand-alone and secure and is not dependent upon an electronic connection to operate. This allows for the use of the software in sometimes remote and unconnected situations. If no connectivity is available during the operation of the group meeting, the data collected in the Remote Node data set can be re-integrated back into the PLANITDIRECT™ System Meeting Planning software via LAN or VPN connection.

The system is oriented around activities sold through the PLANITDIRECT™ System Live Meeting Web Site created by the PLANITDIRECT™ System. This is known as the Remote Field Node. The Live Meeting Web Site's ability to immediately post to a second site or aspect of the system (PLANITDIRECT™ Vendor Node) all details pertaining to each reservation for that vendor/supplier whether it is an individually purchased activity/service or a “hosted” group event—in which case the vendor would have any necessary contact info (group names, hotels, etc.) dates and event descriptions with inclusions required as well as an up-to-date copy of the name-dynamic manifests being gathered and changed via the users on the website (Remote Node). Remote Node's ability to immediately post to Vendor Node all details pertaining to each reservation for that vendor/supplier whether it is an individually purchased activity/service or a “hosted” group event—in which case the vendor would have any necessary contact info (group names, hotels, etc.) dates and event descriptions with inclusions required as well as an up-to-date- copy of the name-dynamic manifests being gathered and changed via the users on the PLANITDIRECT™ System Live Meeting Web Site.

Remote Node.

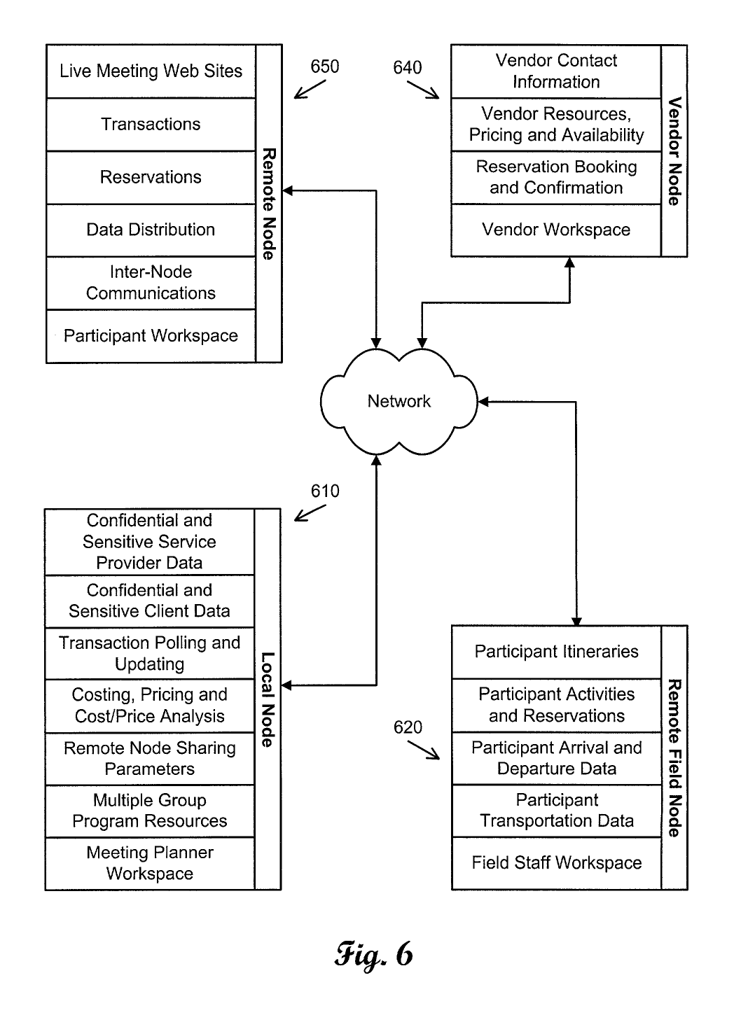

As shown in FIG. 6, the Remote Node is the nexus of communications between the various other nodes of the system as well as being the host for the Live Meeting Web Site. This node takes the information compiled by the group program planner and builds a group specific web site which can then be interacted with by the individual participants for activity purchase, itinerary, scheduling and communications functions.

The Remote Node consists of the data determined by the PLANITDIRECT™ System Meeting Planning software to be necessary for access during the operation of the group meeting program. Remote data is accessible from any computer or digital device via the World Wide Web, Wireless Application Technology or other electronic means. The concept allows for the use of technologies not yet invented or implemented for instant data access from locations removed from the home office and not requiring a dedicated device for access.

Security of the remote data typically consists of user names and passwords to determine the level of access allowed. For instance, group participants may be limited to being able to book activities, view their personal itineraries, modify their arrival and/or departure information or access files designated as public group documents. Individuals logging in as operators would be able to access all of the above information as well as accessing Event, Transportation and Staffing details and Documents designated as operator accessible. Individuals logged in as administrators may be able to access all of the above and also have the ability to modify staffing schedules, change or add available activities, post information intended to be viewed by all participants and modify pricing information as well as accessing all documents available to the Remote Node.

Additionally, the Remote Node is the actual storage repository for all group meeting information that is shared among the various Remote Field Nodes in place for a particular group meeting. This node directs the dedicated e-mail system that is used to communicate amongst the other nodes and handles all shared table and record modifications, additions and updates.

The Remote Node processes all requests for web pages and performs the substitutions for special fields such as contents of individual fields and records contained in the various tables associated with the group, as well as special functions such as e-mail messages indicator and announcement indicators.

The Remote Node also handles all transactions generated by the Live Meeting Web Site. This includes processing credit cards, in the case of financial transactions, as well as processing reservations for transaction-less bookings such as occurs when a participant reserves a spot on a “Hosted” event, i.e. costs covered by the Event organizer, with no charge to the participant. All reservations are also forwarded to the Vendor Node for access by vendors enrolled in the PLANITDIRECT™ System as determined by settings selected by the user in the PLANITDIRECT™ System Meeting Planning software. In the event that the user has elected to have confirmations functions performed by the vendors themselves, the Remote Node retrieves confirmations from the PLANITDIRECT™ Vendor Node and passes this information on to all the various nodes, both Local and Remote, that are affected by the confirmation.

Resource Browser Node.

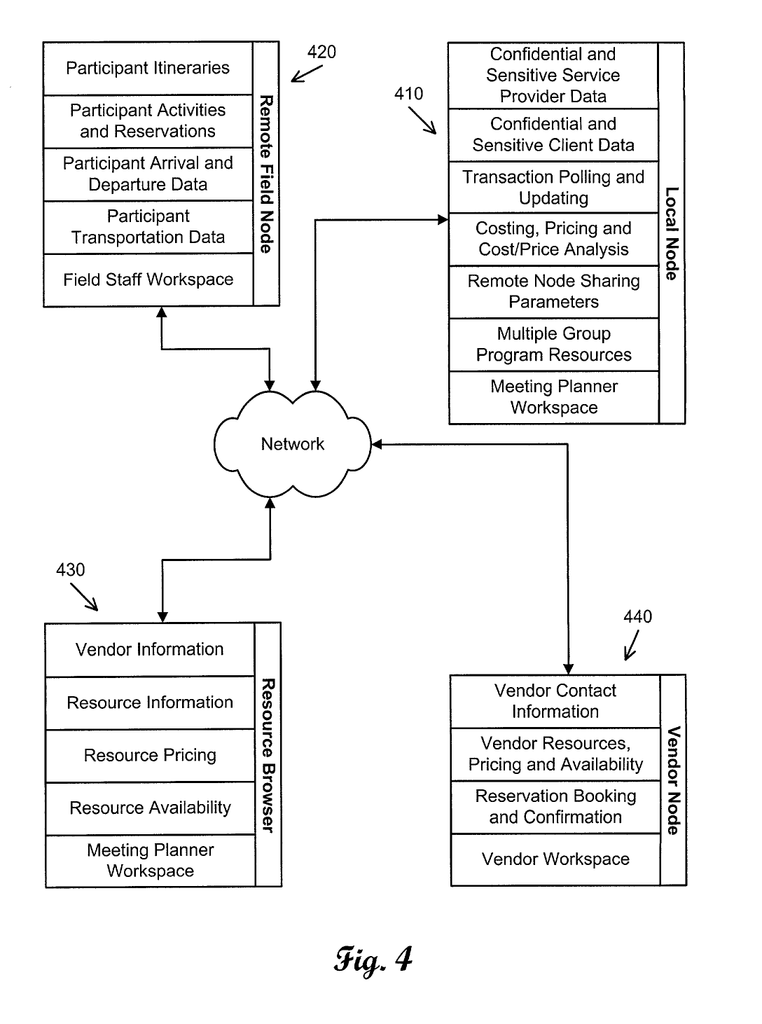

As shown in FIG. 4, the Resource Browser Node (430) is the repository for all universal resources available to users of the PLANITDIRECT™ System. The Resource Browser (430) in the software consists of a common pooling of resources used in a group. The Resource Browser consists of many different types of data, all sharing a common storage format. This allows the resources to be used in a variety of places in the group meeting planning software without having to duplicate individual resources for multiple use. These resources are broken up into several categories: Activities, Transportation, Event Components, Golf Components, Food & Beverage, Labor, Meeting Components and Accommodations. These resources contain vendor information, resource description, pricing information as well as details particular to the resource listed. For instance: Activity type resources also contain fields for input of special instructions and check-in locations to be used when generating vouchers as well as brochure descriptions used when generating documents or sending to remote locations for electronic access. The Resource Browser (430) provides a completely independent set of resources for an individual group allowing the customization of the resources for that group to occur without affecting the original resources or resources set for other group programs. The resources actually used in a particular group meeting are duplicates of resources in the Resource Browser Node. Resources are located by using a web interface and browsing through the available resources for a particular destination. A series of filters and parameters can be used to narrow down the search, such as price point, resource type, availability, etc. Resources may be pre-selected on the Resource Browser web site or may be imported into the PLANITDIRECT™ System Meeting Planning software real-time. Storage of selected sets of resources on the Resource Browser web site can be segregated by group for later decision and import. This allows the meeting planner to access and assemble these resources with the use of a web browser from anywhere without having to have a copy of the PLANITDIRECT™ System Meeting Planning software, whether local or remote, in front of him or her to do so.

Part of the import process is the selection by the user as to which pricing set and/or markup is to be used as well as which date range pricing to import. Once these resources are imported from the Resource Browser Node, they can be customized for a particular group. These customizations can include everything from cost/price changes, customized detailed documentation as well as which modules of the software each resource is to be made available to. The functionality of the Resource Browser Node is duplicated in the PLANITDIRECT™ System Meeting Planning software as a “Main Resource Browser” which allows a user to build a library of customized resources that are available for all of his/her groups. This may be necessary if a vendor not enrolled in the system is used, a particular resource is consistently modified for use in groups or the meeting planner generates their own custom resources for resale to clients. The Main Resource Browser functions the same as the Resource Browser Node except that the resources are stored internally to the PLANITDIRECT™ System Meeting Planning software rather than on the web.

The Resource Browser Node interfaces with two of the other nodes of the system:

PLANITDIRECT™ Vendor Node: This node interfaces with the Resource Browser to allow vendors enrolled in the system to enter their product descriptions, details, pricing and availabilities to allow meeting planner users of the system to access them. The software allows the vendor or a third party to access, maintain, add or modify the wares or services being provided by the vendor, which is being offered to the users of the PLANITDIRECT System. This interfaces directly with the destination management software and becomes the “resources” available by that vendor for a particular destination. This can be accomplished directly via a web site or can be compiled with standalone software and uploaded to the PLANITDIRECT™ System; and

PLANITDIRECT™ System Meeting Planning software: This node interfaces with the Resource Browser to allow meeting planners to browse resources by destination, type or any other parameters via drill-down or filter selection and then import them for use in a particular group meeting.

Multiple Price Sets and Date Range Pricing.

The main resource browser stores multiple sets of pricing information for a particular resource. For instance separate pricing sets may consist of markup percentages used by particular types of groups. One group may get a price based on a 15% markup, while another group may get pricing based on a 30% markup, while yet another type of group may get pricing based on a straight dollar figure markup per activity. In addition, the resource browser also stores date range pricing sets. This allows the user to update pricing for a particular time period while maintaining the current pricing for groups occurring now. This allows for fairly sophisticated price sets such as off-season/peak-season pricing changes.

The vendor, when entering data into the PLANITDIRECT™ Vendor Node selects the date range for which the pricing is intended. An unlimited amount of date ranges may be entered at any one time. When the time comes to bring these resources into a group, the user is prompted to select which pricing set to use as well as which pricing date to use, typically that corresponding to the group meeting start date. The group resources can then be modified directly from within the group. This allows for the independent setting of prices for a particular group without affecting the data in the main resource browser or the data in the resources data sets of other groups. This process can be used to bring in individual resources, multiple selected resources as well as all resources en masse to the group resource browser.

Resources as Objects. Resources as used in the Resource Browser Node can be imported and exported to and from a stand-alone file, as well as stored in XML format to allow transfer between different copies of the system. This file contains all of the information normally associated with a resource including but is not limited to:

Resource Type—Transportation, Activity, Labor, Accommodation, etc.;

Descriptions of the resource;

Region, Sub-Region and Area where resource is available;

Pricing information including set date range, costs, rack prices, multiple sell pricing structures and tax rates;

Detailed information about the resource that would be used in the generation of documents, brochures, web sites, etc.;

Information regarding the provider of the resource including contact information, cancellation policies, buyout policies, insurance requirements, etc.;

A table of inclusions for the resource; and

Images depicting the resource for use in generating documents, brochures, web pages, etc. These images may be included in the object or may consist of Internet URL pointing to the images available on the World Wide Web.

PLANITDIRECT™ Vendor Node.

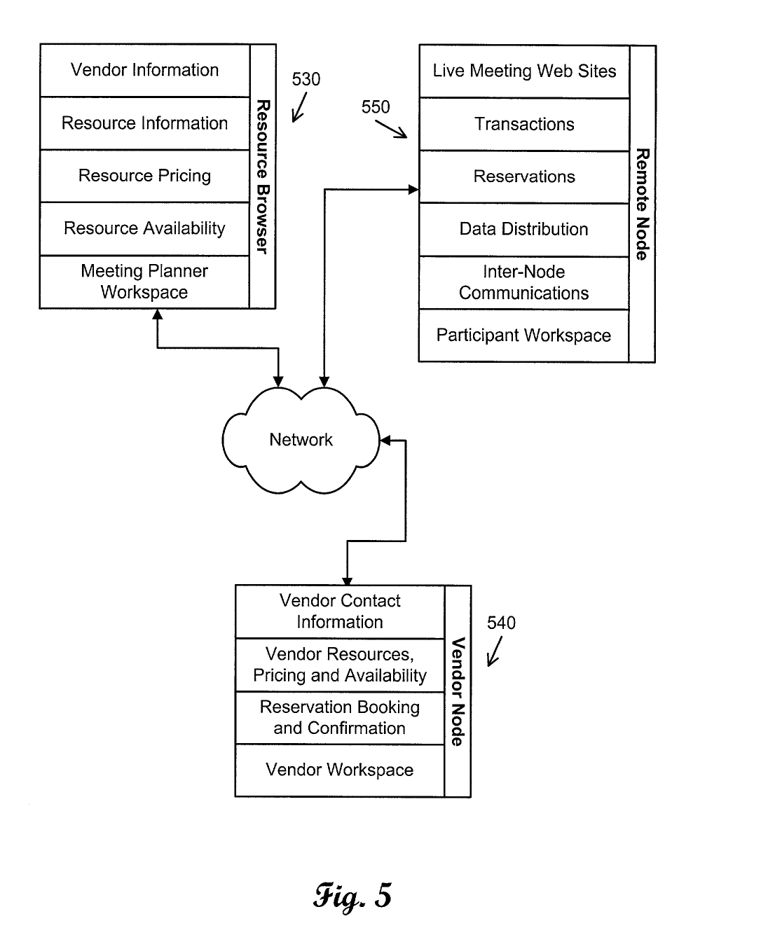

As shown in FIG. 5, the PLANITDIRECT™ Vendor Node (540) allows the vendor to interface directly with the PLANITDIRECT™ System and receive bookings and purchases real-time, as well as enter vendor resource information to made available to users of the PLANITDIRECT™ System. This can be done via a web site interface or via a flavor of the PLANITDIRECT™ Vendor software. The software can also be configured to retrieve and upload data at specific intervals for those vendors without always on connections. In a worst-case scenario, the software can be used as a stand-alone reservations system with manual input by the vendor. The software also enables the vendor to track his wares, and allows for the generation of internal schedules, confirmations and purchaser details. The system is also capable of handling the complexities of activity booking and vendor resource management. In its simplest form, it consists of a standalone PC based reservation system. In its more robust use it has the capability of handling bookings, sales and confirmation via direct electronic communication.

PLANITDIRECT™ Vendor Node is a series of password-protected sites/pages for each vendor/supplier so that they could go to this site and download real-time reservations on an as needed basis. PLANITDIRECT™ Vendor Version will also be a uniform reservation system for the ticketing or confirmation of all other outside sales not generated by the PLANITDIRECT System. A vendor wishing to put up his/her company's services or products for a group may also generate a PLANITDIRECT-Group site for a group of buyers via their own (vendors) version of PLANITDIRECT System software and receive bookings directly to them.

Vendor Resource Entry.

The specific details pertaining to each vendor are entered and stored for use by individuals or other processes accessing this information. This can be as simple as mailing address and contact phone number data and can be as comprehensive as complete contact lists defining departments, payment method information, physical location information, electronic contact information (e-mail, web-site, etc.), deposit requirement policies, cancellation policies and vendor insurance information as well as any other information pertaining to the vendor which may be germane in assisting a prospective purchaser in selecting the particular vendor to supply whatever product may be needed.

Details of all products offered for sale by the vendor may range from a minimal line by line product/cost list to far more complex descriptions which can include, but are not limited to: Detailed product descriptions, Product descriptions designed to target particular audiences (Individual traveler versus meeting planner, for instance), Multiple pricing sets (Adult, Child, Junior, Senior, etc.), multiple date range price sets, photographs depicting the product intended for sale, specific instructions for use (such as check-in locations in the event an activity is being offered for sale) and requirements for purchase or use, e.g., age limitations.

PLANITDIRECT™ System Destination Server Node.

As an option, the PLANITDIRECT™ System Destination Server Node can be used to minimize net congestion for Live Meeting Web Sites by routing the Remote Node to host the group Live Meeting Web Site on a server in close geographical proximity to the group meeting location. This may be necessary when a group meeting is located in a region that has a limited or high traffic Internet connection. The proximity locator has the ability to relocate the actual physical storage location of the web site when the appropriate time comes. For instance, say a group program is being held in Hawaii by a company in New Jersey; before the group start date, the Live Meeting Web Site may be located on an edge server close to New Jersey to minimize hops, but when the group program actually starts, the Live Meeting Web Site will automatically be relocated to an edge server near the Hawaiian islands. In this way, potential slow-downs and perceived delays can be minimized.

We claim:

1. A meeting planning system using a distributed architecture containing a plurality of nodes, comprising: a meeting planning application program running on a server node for entry of data, browsing resources, planning activities and scheduling for a meeting event, generating at least one meeting plan, and exporting the at least one meeting plan with selected meeting data to at least one Remote Node selected from the group comprising: a World Wide Web server node that is accessible to meeting attendees, a secure server node operated by a vendor, a World Wide Web server node operated by a vendor, a secure server node operated by a client, and a World Wide Web server node operated by a client.

2. A system for planning and managing transportation, accommodation, activity, and event reservations using a distributed architecture containing a plurality of nodes, comprising:
a means for accessing information on location-specific vendor resources and for handling direct bookings by members of a group related to the members' participation in a meeting;
a means for vendors to receive reservations and to transact purchases in real-time;
a means for creating and updating at least one World Wide Web site that provides meeting information, entry and updates of reservations, transactions with vendors, and posting of the updated information to selected nodes within the distributed architecture;
a central management system and destination router for routing meeting planner inquiries to the appropriate node; and
a transaction server node that handles at least one transaction selected from the group comprising: billing, commission, and payment.
